(19) United States
(12) Patent Application Publication
(10) Pub. No.: US 2011/0102395 A1
(43) Pub. Date: May 5, 2011

(54) METHOD AND SYSTEM OF CONTROLLING HALT AND RESUME OF SCANNING AN LCD

(75) Inventors: PU-JEN CHENG, Tainan (TW); PEN-HSIN CHEN, Tainan (TW)

(73) Assignee: HIMAX TECHNOLOGIES LIMITED, Tainan (TW)

(21) Appl. No.: 12/770,408

(22) Filed: Apr. 29, 2010

Related U.S. Application Data
(63) Continuation-in-part of application No. 12/612,294, filed on Nov. 4, 2009.

(51) Int. Cl. G06F 3/038

(52) U.S. Cl. 345/208; 345/94

(57) ABSTRACT

A system and method of controlling scanning actions of an LCD is disclosed. A timing controller (Tcon) output enable (OE) generator generates an original OE signal, and a noise detection unit generates a noise-detected signal upon detecting noise. An OE mask generator generates a mask signal according to the noise-detected signal and the original OE signal. A masking unit generates a resultant OE signal according to the mask signal and the original OE signal.

### CROSS-REFERENCE TO RELATED APPLICATIONS

This application is a continuation-in-part (CIP) of U.S. patent application Ser. No. 12/612,294 (Att. Docket HI8327P), filed on Nov. 4, 2009, entitled “METHOD AND SYSTEM OF CONTROLLING HALT AND RESUME OF SCANNING AN LCD.”

### BACKGROUND OF THE INVENTION

1. Field of the Invention

The present invention generally relates to a liquid crystal display (LCD), and more particularly to a system and method of controlling halt and resumption of scanning actions of an LCD.

2. Description of Related Art

Liquid crystal display (LCD) technology has been widely used in television sets and a variety of other electronic devices. According to specific characteristics of liquid crystal molecules, a polarity inversion scheme is commonly applied to change the direction of electric field at regular intervals such as frame, column, row or dot, such that the polarity of the electric field changes every frame, column, row or dot. FIG. 1 shows two neighboring frames for which row inversion scheme is utilized. In frame N, the polarity of the first row is positive “+”, and the polarity of the second row is changed to negative “−”, and so on. In frame N+1, however, the polarity of the first row is negative “−”, which is the inverse of the polarity of the same row in the preceding frame N.

Television broadcasting, and electrical communication in general, is commonly subject to noise or disturbance. An LCD television set that receives such noise may cause annoyance to viewers. FIG. 2 shows an example in which frame N suffers noise beginning at the fourth row, and therefore display of the remaining rows is stopped. After recovering from the interruption, frame N+1 starts the display from the first row. It is noted that the last display row (i.e., the third row) in frame N and the continuing row (i.e., the fourth row) in frame N+1 has the same polarity “+”. Consequently, this situation, as indicated by the arrow in the figure, may cause flicker to viewers.

For the reason that conventional LCDs cannot effectively recover from an inevitable interruption caused, for example, by noise, a need has arisen to propose a novel scheme that may avoid flicker or other annoyance induced during the recovery from display interruption.

### SUMMARY OF THE INVENTION

In view of the foregoing, it is an object of the embodiment of the present invention to provide a system and method of controlling halt and resumption of scanning actions of an LCD in order to make the recovery from a display interruption smoother or more continuous with less or no flicker.

It is another object of the embodiment of the present invention to block one or more scan lines corresponding to a video source with noise from being disturbingly displayed on an LCD panel.

According to one embodiment, an incoming video source is monitored to detect abnormality of the video source, and current scan line position and corresponding polarity are recorded. The panel scanning of the LCD is stopped when an abnormality of the video source is detected, wherein the scan line for which the panel begins to stop scanning is defined as a halt scan line, its corresponding polarity is defined as a halt polarity, and its associated frame is defined as a halt frame. After a normal video source has been detected again, determination is made of one or both of the following parameters: a resumptive scan line that has a position equal to that of the halt scan line with respect to a first pixel of respective frame; and a resumptive polarity such that a resumptive frame has the same polarity as the halt frame. The panel scanning is then resumed on one or both of the following conditions: at the resumptive scan line; and when the polarity of the resumptive frame matches the polarity of the halt frame.

According to another embodiment, a timing controller (Tcon) output enable (OE) generator generates an original OE signal, and a noise detection unit generates a noise-detected signal upon detecting noise. An OE mask generator generates a mask signal according to the noise-detected signal and the original OE signal. For example, the mask signal becomes asserted when the noise-detected signal becomes asserted and a predetermined setting time has elapsed since a state transition of the original OE signal within a current cycle time. On the other hand, the mask signal becomes de-asserted when the noise-detected signal becomes de-asserted and a data-processing time has elapsed, during which video data to be displayed on the LCD have been processed and become ready. Finally, a masking unit generates a resultant OE signal according to the mask signal and the original OE signal. For example, the original OE signal is blocked by the masking unit whenever the mask signal becomes asserted; otherwise, the resultant OE signal follows the original OE signal.

### BRIEF DESCRIPTION OF THE DRAWINGS

FIG. 1 shows two neighboring frames for which row inversion scheme is utilized;

FIG. 2 shows an example in which frame N suffers noise and frame N+1 recovers from the interruption caused by the noise;

FIG. 3 shows a functional block diagram of a liquid crystal display (LCD);

FIG. 4 shows a functional block diagram that illustrates a system of controlling halt and resumption of scanning actions of an LCD;

FIG. 5 shows a flow diagram that illustrates a method of controlling halt and resumption of scanning actions of an LCD;

FIG. 6A shows an exemplary timing diagram that illustrates a start signal STV and the output enable signal OE according to one embodiment of the present invention;

FIG. 6B shows an expanded timing diagram that illustrates the start signal STV, the output enable signal OE, and the polarity inversion signal POL at about the time t1 of FIG. 6A;

FIG. 6C shows an expanded timing diagram that illustrates the start signal STV, the output enable signal OE, and the polarity inversion signal POL at about the time t2 of FIG. 6A;

FIG. 7 shows a block diagram that illustrates a system of controlling scanning actions of an LCD according to another embodiment of the present invention;

FIG. 8 shows a flow diagram that illustrates a method of controlling scanning actions of an LCD;

FIG. 9 shows exemplary waveforms of main signals in FIG. 7; and

FIG. 10 exemplifies an implemented circuit of the masking unit in FIG. 7.

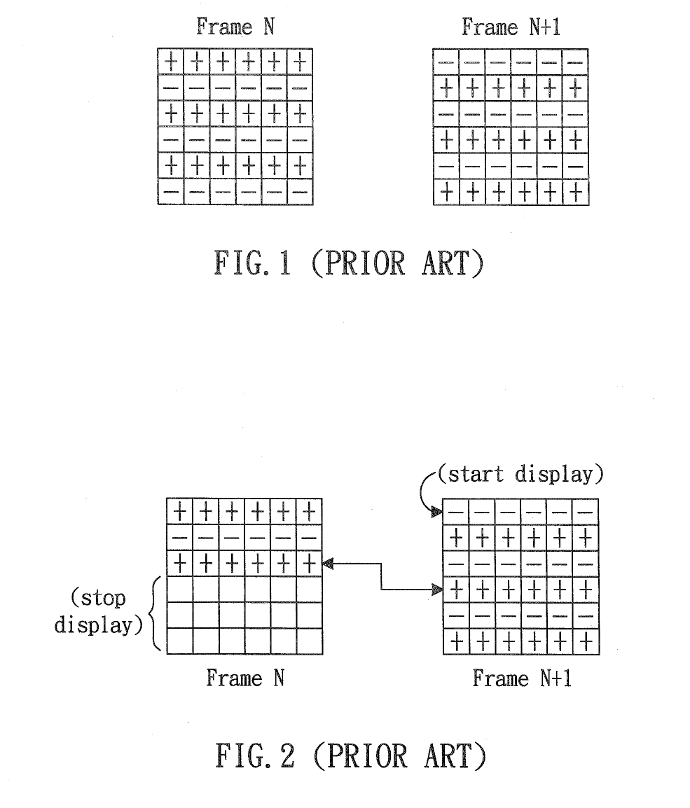

### DETAILED DESCRIPTION OF THE INVENTION

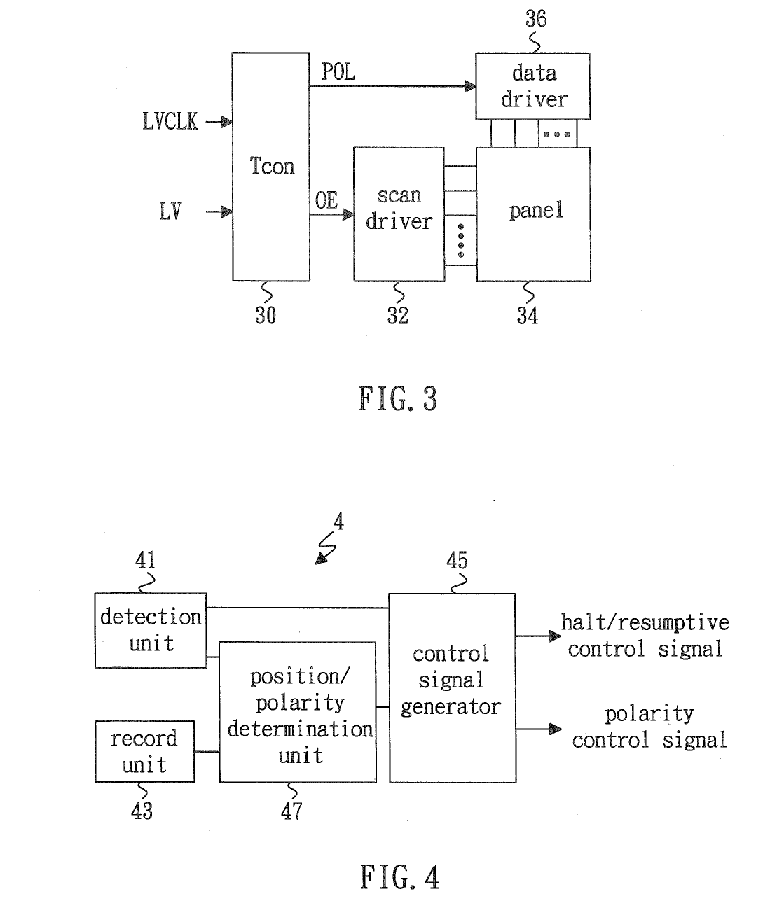

FIG. 3 shows a functional block diagram of a liquid crystal display (LCD). A timing controller (Tcon) 30 receives, among others, a video source such as a low-voltage differential signaling (LVDS) video signal LV, and a corresponding video clock LVCLK. The timing controller 30 generates an output enable signal OE to a scan driver (or gate driver) 32. When the output enable signal OE is assertive (e.g., “0”), the scan driver 32 scans rows of pixels of an LCD panel 34 in sequence; and when the output enable signal OE is de-assertive (e.g., “1”), the scan driver 32 stops scanning the panel 34. The timing controller 30 also generates a polarity inversion signal POL to a data driver (or source driver) 36 such that the video data out of the data driver 36 may have appropriate voltage potential in compliance with the polarity of associated pixels.

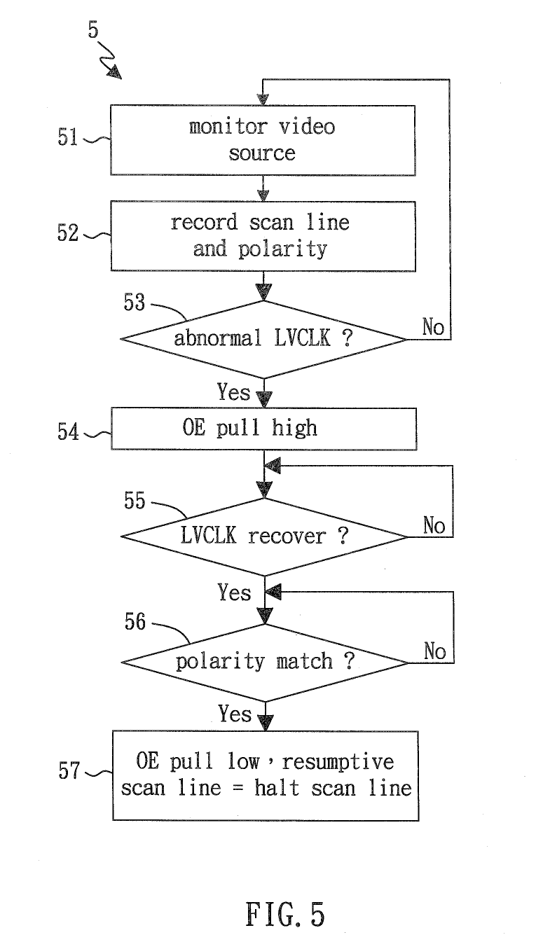

FIG. 4 shows a functional block diagram that illustrates a system 4 of controlling halt and resumption of scanning actions of an LCD, such as the LCD shown in FIG. 3. FIG. 5 shows a flow diagram 5 that illustrates a method of controlling halt and resumption of scanning actions of an LCD.

In the embodiment, the system 4 may be implemented within the timing controller 30 of FIG. 3. A detection unit 41 monitors the incoming video source to detect any abnormality of the video source (step 51). Specifically, in the embodiment, the detection unit 41 monitors the video clock LVCLK to determine whether the frequency of the video clock LVCLK is within limits that define the range of a normal video clock LVCLK. An abnormal video clock LVCLK may indicate that the video signal LV is being affected by noise or disturbance.

Concurrently with the monitoring, a record unit 43 continuously or regularly records current scan line position and corresponding polarity (step 52). For example, with respect to a line inversion scheme, the current scan line position (or number) and its corresponding polarity are recorded.

When the detection unit 41 detects abnormality of the incoming video clock LVCLK (step 53), a control signal generator 45 accordingly generates (e.g., via an output) a halt/resumptive control signal, which is then used to de-assert (or pull-high) the output enable signal OE in order to stop scanning of the panel 34 (step 54). Accordingly, the display scan is halted. At the same time, the halt scan line is peculiarly recorded by the record unit 43. In other words, the scan line for which the panel 34 begins to stop displaying is peculiarly marked as the halt scan line. Moreover, a halt polarity associated with the halt scan line or associated with the first pixel of the halt frame is also recorded.

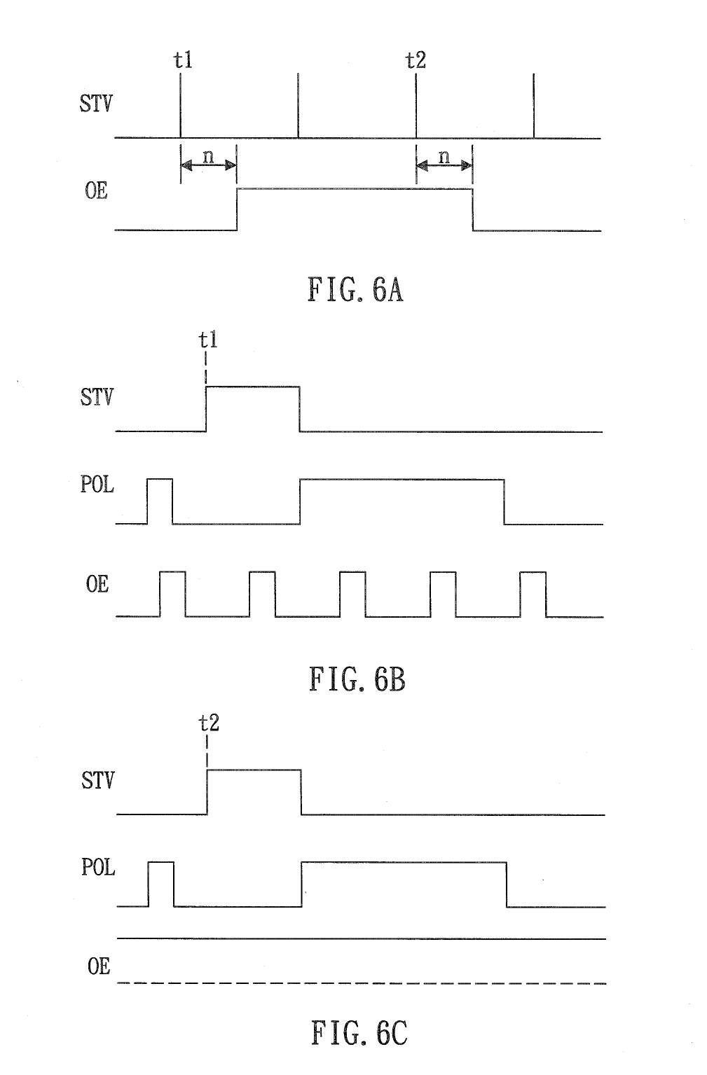

FIG. 6A shows an exemplary timing diagram that illustrates a start signal STV and the output enable signal OE according to one embodiment of the present invention. The start signal STV, which is usually derived from a vertical synchronization signal, indicates the start of a frame. In this timing diagram, the output enable signal OE is completely pulled high because of noise interruption at the n-th scan line of the halt frame beginning at t1. In other words, the halt scan line is the n-th line in the example. FIG. 6B shows an expanded timing diagram that illustrates the start signal STV, the output enable signal OE, and the polarity inversion signal POL around (e.g., at about) the time t1 of FIG. 6A. According to the exemplary timing diagram of FIG. 6B, the halt polarity associated with the first pixel of the frame is negative “−”.

Afterward, when the detection unit 41 detects the recovery of the incoming video clock LVCLK (step 55), a position/polarity determination unit 47 accordingly determines an appropriate position (or scan line) and polarity to resume scanning the panel 34. In the embodiment, the position/polarity determination unit 47 maintains the halt status until a resumptive polarity of a frame is matched (or the same as) the halt polarity (step 56). Upon matching the polarity, the output enable signal OE is asserted (or pulled low), and the scan resumes at a resumptive scan line that is equal to (or the same as) the halt scan line (step 57). At that time, the control signal generator 45 generates a polarity control signal, for example, to the timing controller 30 in order to output a proper polarity inversion signal POL to the data driver 36. According to another embodiment, instead of waiting for the polarity to be matched, the polarity of the electric field is forced to be the resumptive polarity at the resumptive scan line.

Referring to FIG. 6A, after the polarity matching, the output enable signal OE is pulled low at the n-th scan line of the resumptive frame beginning at t2. In other words, the resumptive scan line is the n-th line, which is equal to the halt scan line. FIG. 6C shows an expanded timing diagram that illustrates the start signal STV, the output enable signal OE, and the polarity inversion signal POL around (e.g., at about) the time t2 of FIG. 6A. According to the exemplary timing diagram of FIG. 6C, the resumptive polarity associated with the first pixel of the frame is negative “−”.

According to the embodiment described above, the resumptive scan line may thus resume scanning of the panel 34 in a smooth manner by starting the resumptive scan line exactly at the halt scan line. In addition to the same position, the polarity of the resumptive scan line may thus be the same as the polarity of the halt scan line. Accordingly, flicker or other annoyance induced during the conventional recovery from the display interruption may be avoided, thereby improving the quality of video display.

According to another embodiment of the present invention, a polarity determination unit is used instead of the position/polarity determination unit 47 (FIG. 4). In the present embodiment, the recording of the halt scan line and the determination of the resumptive scan line are not necessary. Upon matching the polarity (step 56), the scan resumes at the first scan line (rather than the resumptive scan line as in the previous embodiment) of the resumptive frame.

According to a further embodiment, a position determination unit is used instead of the position/polarity determination unit 47 (FIG. 4). In the present embodiment, the recording of the halt polarity and the determination of the resumptive polarity are not necessary. When the detection unit 41 detects the recovery of the incoming video clock LVCLK (step 55), the scan resumes, for example in the current frame or next frame, at a resumptive scan line that is equal to (or the same as) the halt scan line (step 57).

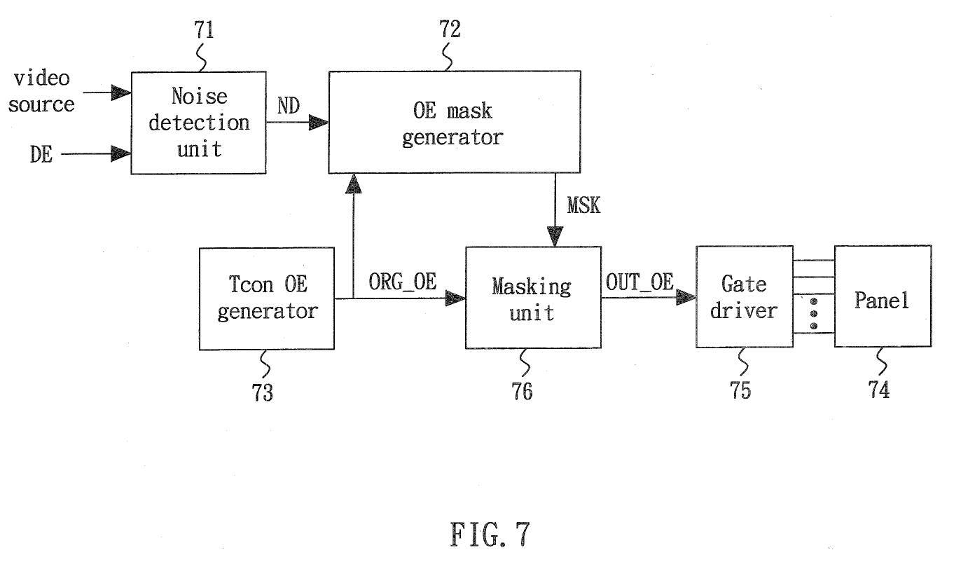

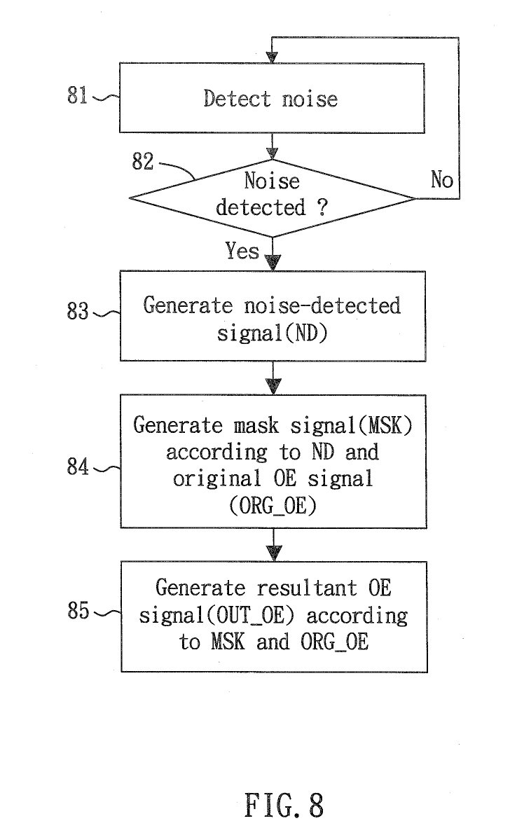

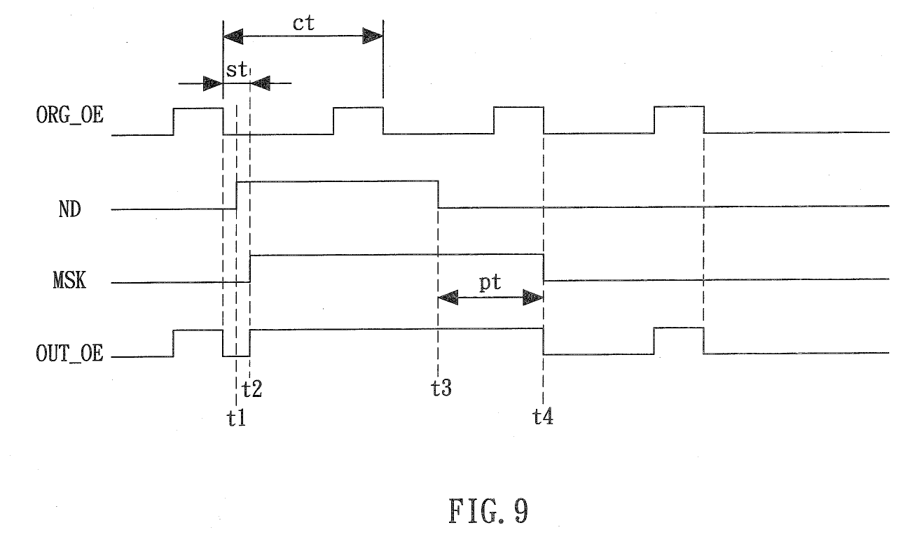

FIG. 7 shows a block diagram that illustrates a system of controlling scanning actions of an LCD according to another embodiment of the present invention. FIG. 8 shows a flow diagram that illustrates a method of controlling scanning actions of an LCD, and FIG. 9 shows exemplary waveforms of main signals in FIG. 7.

In the embodiment, in step 81, a noise detection unit 71 monitors an incoming video source in order to detect any noise that, for example, has an amplitude greater than a predetermined threshold value. In another embodiment, the noise detection unit 71 monitors a data enable signal DE to detect the noise when the width of the asserted data enable signal DE is too large (e.g., larger than a predetermined maximum value) or is too small (e.g., smaller than a predetermined minimum value). Upon detecting the noise (step 82), the noise detection unit 71 generates a noise-detected signal ND (step 83), for example, by asserting or pulling the noise-detected signal ND to a high level. As exemplified in FIG. 9, noise is detected at time t1 and is undetected at time t3.

An output enable (OE) mask generator 72 then, in step 84, generates a mask signal MSK according to the noise-detected signal ND and an original output enable (OE) signal ORG_OE that is generated from a timing controller (Tcon) output enable (OE) generator 73. As exemplified in FIG. 9, a scan line is supposed to be displayed on an LCD panel 74 during a cycle time ct. The OE mask generator 72 may be integrated with the timing controller (Tcon) or may be individually built.

In the embodiment, the mask signal MSK becomes asserted (or pulled high) when the following two conditions have been met: (1) the noise-detected signal ND becomes asserted, and (2) a predetermined setting time st has elapsed since a state transition (e.g., the de-asserting transition or falling edge) of the original OE signal ORG_OE within the current cycle time ct. However, in another embodiment, the mask signal MSK becomes asserted when only the condition (1) has been met. The purpose of the condition (2) is to prevent a surge or impulse signal occurred at the input of a gate driver (or scan driver) 75 and associated abnormal voltage at the output of the gate driver 75. As exemplified in FIG. 9, the mask signal MSK becomes asserted or pulled high at time t2 according to the asserted noise-detected signal ND (at time t1) and the setting time st.

Afterwards, the mask signal MSK becomes de-asserted (or pulled low) when the following two conditions have been met: (a) the noise-detected signal ND becomes de-asserted, and (b) a data-processing time pt has elapsed during which video data to be displayed on the panel 74 have been processed and become ready. However, in another embodiment, the mask signal MSK becomes de-asserted when only the condition (a) has been met. As exemplified in FIG. 9, the mask signal MSK becomes de-asserted or pulled low at time t4 according to the de-asserted noise-detected signal ND (at time t3) and the data-processing time pt. According to respective data-processing power, one or more periods of the cycle time ct may be additionally added in the data-processing time pt.

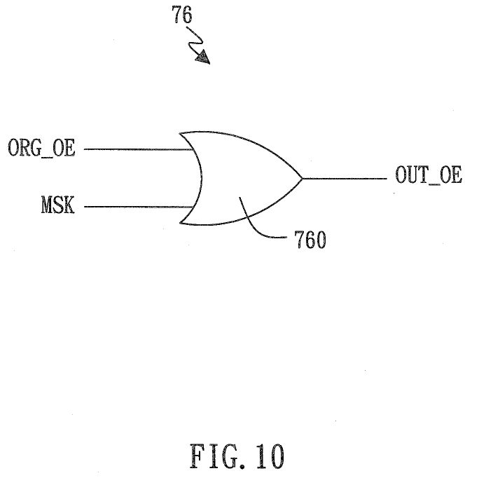

Subsequently, based on the mask signal MSK and the original OE signal ORG_OE, a masking unit 76 generates a resultant OE signal OUT_OE in step 85. The resultant OE signal OUT_OE is fed to the gate driver 75 that controls the scanning actions of the panel 74. The masking unit 76 may be integrated with the timing controller (Tcon) or may be individually built. According to the embodiment, the original OE signal ORG_OE is masked or blocked whenever the mask signal MSK is asserted. In other words, a normal display on the panel 74 is halted. FIG. 10 exemplifies an implemented circuit of the masking unit 76 in FIG. 7. In the exemplary embodiment, a logic OR gate 760 couples to receive the original OE signal ORG_OE and the mask signal MSK, and then outputs the resultant OE signal OUT_OE. As a result, the resultant OE signal OUT_OE becomes de-asserted (between time t2 and time t4) whenever the mask signal MSK becomes asserted. Otherwise, when the mask signal MSK becomes de-asserted, the resultant OE signal OUT_OE follows the original OE signal ORG_OE, thereby resuming the normal display on the panel 74.

According to the embodiment disclosed above, one or more scan lines may be skipped or blocked when noise is detected in the video source. As a result, the video source with noise will not be displayed on the panel 74 in a disturbing or annoying manner. Owing to memory or retention effect of the liquid crystal molecules in the LCD, the corresponding blocked scan line or lines of the preceding frame before noise detected may be temporarily retained on the panel 74. Accordingly, the blocked scan line or lines will not have substantive affect on the image quality.

Although specific embodiments have been illustrated and described, it will be appreciated by those skilled in the art that various modifications may be made without departing from the scope of the present invention, which is intended to be limited solely by the appended claims.

What is claimed is:

1. A system of controlling scanning actions of an LCD, comprising:
a timing controller (Tcon) output enable (OE) generator configured to generate an original OE signal;
a noise detection unit configured to generate a noise-detected signal upon detecting noise;
an OE mask generator configured to generate a mask signal according to the noise-detected signal and the original OE signal; and
a masking unit configured to generate a resultant OE signal according to the mask signal and the original OE signal.

2. The system of claim 1, wherein the noise-detected signal becomes asserted when the noise has an amplitude greater than a predetermined threshold value.

3. The system of claim 1, wherein the noise-detected signal becomes asserted when a width of an asserted data enable signal is larger than a predetermined maximum value or is smaller than a predetermined minimum value.

4. The system of claim 1, wherein the mask signal becomes asserted when the noise-detected signal becomes asserted; and the mask signal becomes de-asserted when the noise-detected signal becomes de-asserted.

5. The system of claim 1, wherein the mask signal becomes asserted when the noise-detected signal becomes asserted and a predetermined setting time has elapsed since a state transition of the original OE signal within a current cycle time.

6. The system of claim 5, wherein the state transition is a de-asserting transition of the original OE signal.

7. The system of claim 1, wherein the mask signal becomes de-asserted when the noise-detected signal becomes de-asserted and a data-processing time has elapsed, during said data-processing time video data to be displayed on the LCD have been processed and become ready.

8. The system of claim 7, wherein one or more periods of cycle time of the original OE signal are further added in the data-processing time.

9. The system of claim 1, wherein the original OE signal is blocked by the masking unit whenever the mask signal becomes asserted; otherwise, the resultant OE signal follows the original OE signal.

10. The system of claim 9, wherein the masking unit comprises a logic OR gate that couples to receive the original OE signal and the mask signal, and accordingly outputs the resultant OE signal.

11. The system of claim 1, wherein the resultant OE signal is fed to a gate driver that controls the scanning actions of the LCD.

12. A method of controlling scanning actions of an LCD, comprising:
generating an original out enable (OE) signal;
generating a noise-detected signal upon detecting noise;
generating a mask signal according to the noise-detected signal and the original OE signal; and
generating a resultant OE signal according to the mask signal and the original OE signal.

13. The method of claim 12, wherein the noise-detected signal is asserted when the noise has an amplitude greater than a predetermined threshold value.

14. The method of claim 12, wherein the noise-detected signal becomes asserted when a width of an asserted data enable signal is larger than a predetermined maximum value or is smaller than a predetermined minimum value.

15. The method of claim 12, wherein the mask signal is asserted when the noise-detected signal becomes asserted; and the mask signal is de-asserted when the noise-detected signal becomes de-asserted.

16. The method of claim 12, wherein the mask signal is asserted when the noise-detected signal becomes asserted and a predetermined setting time has elapsed since a state transition of the original OE signal within a current cycle time.

17. The method of claim 16, wherein the state transition is a de-asserting transition of the original OE signal.

18. The method of claim 12, wherein the mask signal is de-asserted when the noise-detected signal becomes de-asserted and a data-processing time has elapsed, during said data-processing time video data to be displayed on the LCD have been processed and become ready.

19. The method of claim 18, wherein one or more periods of cycle time of the original OE signal are further added in the data-processing time.

20. The method of claim 12, wherein the original OE signal is blocked by the masking unit whenever the mask signal becomes asserted; otherwise, the resultant OE signal follows the original OE signal.

21. The method of claim 20, in the step of generating the resultant OE signal, a logic OR operation is performed on the original OE signal and the mask signal, and accordingly outputs the resultant OE signal.

22. The method of claim 12, further comprising feeding the resultant OE signal to a gate driver that controls the scanning actions of the LCD.
